(19) United States
(12) Patent Application Publication
(10) Pub. No.: US 2009/0093258 A1
(43) Pub. Date: Apr. 9, 2009

(54) Instant communication module capable of positioning a contact and method thereof

(75) Inventor: Xiao Long Teng, Shanghai (CN)

Correspondence Address: HUDAK, SHUNK & FARINE, CO., L.P.A., 2020 FRONT STREET, SUITE 307, CUYAHOGA FALLS, OH, 44221, US

(73) Assignees: MITAC INTERNATIONAL CORP., Taoyuan (TW); MITAC RESEARCH (SHANGHAI) LTD., Shanghai (CN)

(21) Appl. No.: 12/151,692

(22) Filed: May 8, 2008

(30) Foreign Application Priority Data
Oct. 8, 2007 (TW) 096137731

(51) Int. Cl. H04Q 7/20

(52) U.S. Cl. 455/456.2

(57) ABSTRACT

An instant communication module capable of positioning a contact and method thereof are disclosed. The instant communication module can send out a position request to a remote module by using an instant communication program. If the remote module accepts the position request, it will respond a location data back to the instant communication module so as the instant communication module can display the location data on an electronic map. Therefore, the user can exchange message with his/her friends' and know their location via instant communication module.

### FIELD OF THE INVENTION

The present invention relates to an instant communication module, and more particularly to the instant communication module capable of positioning a contact rapidly through a global positioning system (GPS).

### BACKGROUND OF THE INVENTION

At present, with the growing of the digital technology and the internet, the popularity and the convenience of using the instant communication platform regard to the internet as an interface has increased accordingly, it does not need the complex formality, and a user usually only needs to use a keypad to entry a message, and can check over the message with others through the internet.

More particularly, the improvement of the digital electronic apparatus, such as the mobile phones, make sharing the digital image and instant message becomes more universality. The user can exchange any information with others. However, during the time of information exchanging, it is unable to know the position of the contacts, such as the appointment place with friends or the position of the contacts, so that users normally ask friend for location by entering the message using the keypad, and it makes the user unable to get in touch with people's position immediately and will delay a lot of users' time.

In view of the drawbacks of the prior art, the inventor of the present invention based on years of experience to conduct extensive researches and experiments, and finally developed an instant communication module capable of positioning a contact and method thereof to overcome the drawbacks of the prior art.

### SUMMARY OF THE INVENTION

Accordingly, the objective of the present invention is to provide an instant communication module capable of positioning a contact and the method thereof to solve the issue of wasting time form unknowing the position of contact.

To achieve the foregoing objective, the present invention provides an instant communication module capable of positioning a contact, comprising a signal transmitting and receiving unit, a navigation unit, a storage unit, a processing unit and a display unit. The signal transmitting and receiving unit is used for transmitting and receiving at least one signal. The navigation unit is used for providing a location data and comprises an electronic map database for storing a plurality of map data. The storage unit is used for storing an instant communication program. The processing unit is operable to execute the instant communication program for exchanging a plurality of instant messages and a positing request with at least one remote module at an instant message platform by the signal transmitting and receiving unit. The remote module sends a remote location data to the signal transmitting and receiving unit after receiving the position request. The processing unit positions and displays the location of the remote module on the map data based on the received remote location data. The display unit is used for displaying a visual operation interface of the instant communication program which can show the instant message and the location of the remote module.

In addition, the present invention further provides a method of positioning a contact. The method is applied for an instant communication module and includes the following steps of:
i) executing an instant communication program in said instant communication module for exchanging a plurality of instant messages and a position request with at least one remote module;
ii) searching whether there is a location data about said remote module or not, and displaying the location of said remote module if a location data about said remote module is searched, or sending a position request to said remote module if no location data about said remote module is searched;
iii) determining by a user who operates said remote module whether to respond said position request or not, and sending a location data of said remote module to said instant communication module if said user accepts the position request; and
iv) searching a map data corresponding to said location data of said remote module from an electronic map database and displaying said location data on said map data.

### BRIEF DESCRIPTION OF THE DRAWINGS

The subject matter regarded as the invention is particularly pointed out and distinctly claimed in the concluding portion of the specification. The invention, both as to module and method of operation, together with features and advantages thereof may best be understood by reference to the following detailed description with the accompanying drawings in which:

FIG. 1 is a schematic block diagram of an instant communication module capable of positioning a contact in accordance with the present invention;

FIG. 2 is a schematic block diagram of an embodiment of the instant communication module capable of positioning a contact in accordance with the present invention;

FIG. 3 is a schematic block diagram of another embodiment of the instant communication module capable of positioning a contact in accordance with the present invention; and

FIG. 4 is a flow chart of the method of positioning a contact in accordance with the present invention.

### DETAILED DESCRIPTION OF THE PREFERRED EMBODIMENTS

The forgoing and other objectives, features and advantages of the present invention will be better understood from the following detailed description taken with the accompanying drawing, and the same referring numerals are used for the same components in accordance with the present invention.

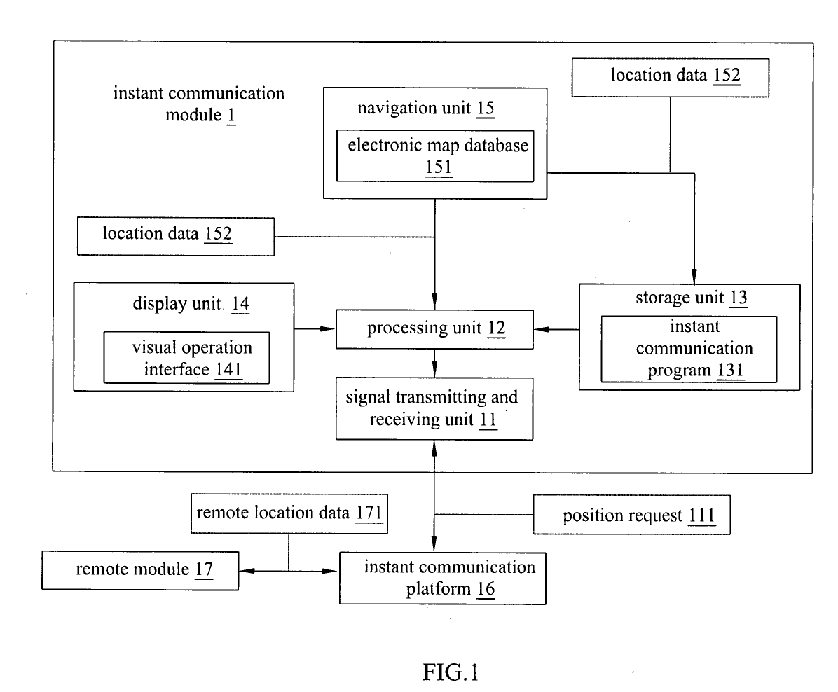

FIG. 1 illustrates a schematic block diagram of an instant communication module capable of positioning a contact of the present invention. In the figures, the instant communication module 1 comprises a signal transmitting and receiving unit 11, a processing unit 12, a storage unit 13, a display unit 14 and a navigation unit 15. The signal transmitting and receiving unit 11 is used for transmitting and receiving at least one signal. The navigation unit 15 is used for providing a location data 152 and has an electronic map database 151 for storing a plurality of map data. Preferably, the navigation unit 15 can comprise a GPS module, a digital compass or a gyroscope. The GPS module can receive GPS data from GPS satellites and determine its present location based on the GPS data, and the location data 152 can contain a GPS coordinate data containing a longitude and latitude. The digital compass can measure its directional orientation. The gyroscope can measure its rotational orientation based on the principle of conservation of angular momentum.

The storage unit 13 is used for storing an instant communication program 131 which is executed by the processing unit 12 for exchanging a plurality of instant messages and a position request 111 with at least one remote module 17 at an instant communication platform 16 by the signal transmitting and receiving unit 11. After receiving the position request 111, the remote module 17 sends a remote location data 171 to the signal transmitting and receiving unit 11. Preferably, the remote module 17 can be another instant communication module 1, and the remote location data 171 is the location of the remote module 17.

The processing unit 12 positions and displays the location of the remote module 17 on the map data based on the received remote location data 171. The display unit 14 is used for displaying a visual operation interface 141 of the instant communication program 131. The visual operation interface 141 comprises at least a dialog box and a map display box for displaying the instant message and the location of the remote modules 17.

Preferably, the signal transmitting and receiving unit is a GPRS transmission module or a WIFI transmission module. Preferably, the processing unit 12 is a microprocessor. Preferably, the storage unit 13 is a memory, such as DRAM, flash memory or ROM. Preferably, the display unit 14 is a display screen. The instant communication program 131 is a Skype program, a MSN program or other telephone software program. The instant message is a text message or a multimedia message.

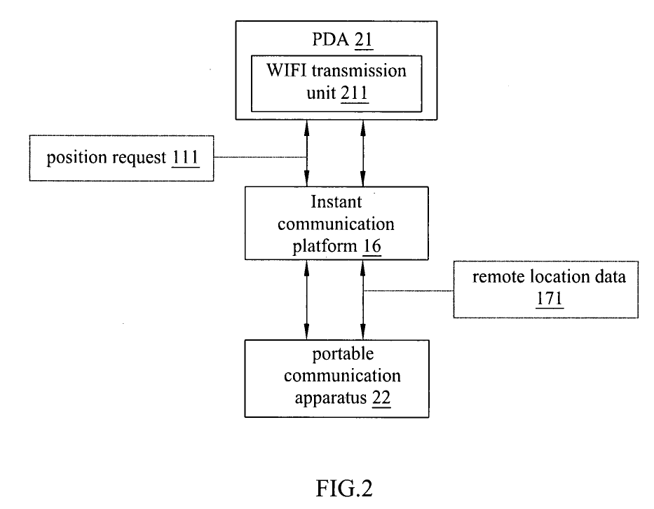

FIG. 2 illustrates a schematic block diagram of an embodiment of the instant communication module capable of positioning a contact in accordance with the present invention. When a user wants to know the position of his/her friends in order to choice an appropriately place to meet friends, the user can utilize a personal digital assistants (PDA) 21 to execute an instant communication program to inquire whether there is any friend's position data existed. If there is none data existed, it can utilize a WIFI transmission module 211 being at an instant communication platform 16 to process a procedure of logging on. If his/her friends also use the portable communication apparatus 22 to log on the instant communication platform 16, then the users can use visual operation interface of the instant communication program to sent a position request 111 to his/her friends. The portable communication apparatus 22 then displays a position request, such as “Would you mind to offer your position to someone?” If the friends agree this positioning demand 111, the portable communication apparatus 22 responses the remote location data 171 back to the personal digital assistance 21. The personal digital assistance 21 then search a map data corresponding to the remote location data 171 from the built-in electronic map database and display accordingly on the personal digital assistance 21. If no map data is found from the electronic map database, the personal digital assistance 21 can use a built-in network map network map searching unit to search a network map corresponding to the remote information 171 from the internet and display accordingly on the personal digital assistance 21.

Preferably, the instant communication platform 16 can be a server which is maintained by the instant communication program provider. After connecting with the instant communication platform 16, the PDA and the portable communication apparatus 22 can continuously transmit their current location to the instant communication platform 16 for exchanging to each other, so that the user and his/her friends can share their location in real time.

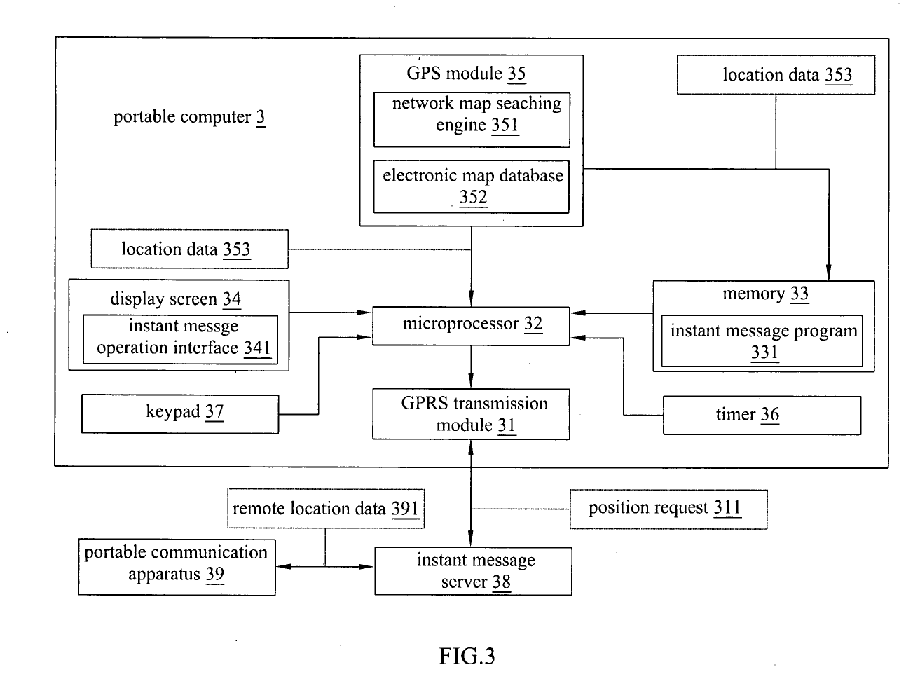

FIG. 3 illustrates a schematic block diagram of another embodiment of the instant communication module capable of positioning a contact in accordance with the present invention. The portable computer 3 comprises a GPRS transmission module 31, a microprocessor 32, a memory 33, a display screen 34, a global positioning system (GPS) module 35, a timer 36 and a keypad 37. The memory 33 stores an instant message program 331. The keypad 37 is used for allowing the user to enter data. The GPS module 35 is used for receiving the signals from at least four satellites to calculate a present location data 353 of the portable computer 3, and comprises an electronic map database 352 which is used for storing a plurality of map data. The portable computer 3 uses the GPRS transmission module 31 to exchange a signal with a portable communication apparatus 39.

Microprocessor 32 executes the instant message program and logs on to an instant message server 38 through the GPRS transmission module 31. A user can execute the instant message program 331 by using the portable computer 3 to know the location of the contact using the portable communication apparatus 39. After the contact has logged on to the instant message server 38, the user of the portable computer 3 can enter a searching commend to the microprocessor 32 to search whether there is any location data about the portable communication apparatus 39 existed in the portable computer 3. If there is no data existed, the user can use the instant message operation interface 341 of the instant message program 331 to sent out a position request 311 to his/her friends. After receiving the position request 311, the portable communication apparatus 39 then display a message of the position request 311. If the contact accepts the request and enters a responding command, the portable communication apparatus 39 will send a remote location data 391 to the portable computer 3.

After the portable computer 3 receives the remote location data 391, the microprocessor 32 searches a map data corresponding to the remote location data 391 from the electronic map database and then displays the remote location data 391 on the map data which exhibited on the display screen 34. Preferably, the global positioning system 35 can further comprise a network map searching engine 351. If no map data corresponding to the remote location data are founded from the electronic map database 352, the microprocessor 32 can use the network map searching engine 351 to search a network map corresponding to the remote location data from a website. The network map searching engine 351 is a GOOGLE MAP.

When a group of friends get together, it perhaps has too much transportation and may be unable to know each friend position immediately. Besides, it may give the drivers having a lot of inconveniences if sending out the position request 311 to everyone. Therefore, it can use the timer 36 to count a fixed time. The microprocessor 32 can get the location data 353 through the global positioning system 35. The timer 36 can then provide the location data 353 so that it can upgrade every friend position in the map data or the network map. Here, the above-mentioned only executes as examples and therefore not limit within above examples. The technology of follow-up GPS's positioning is known in the art so that no details go into here.

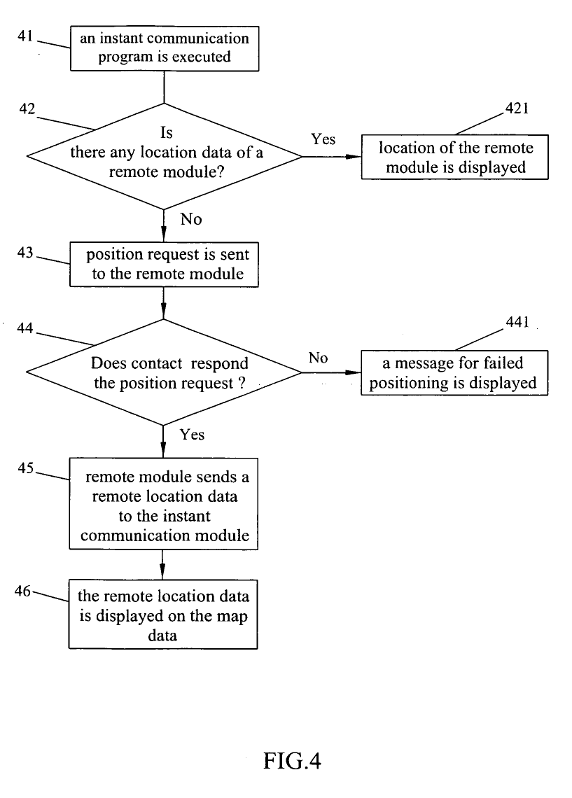

FIG. 4 illustrates a flow chart of method of positioning a contact in accordance with the present invention. The method is applied for an instant communication module, and includes the following steps. In step 41 an instant communication program is executed to log on an instant message platform for searching the information about at least one contact, and then checking whether there is any location data of a remote module which is operated by the contact to log on the instant message platform, in step 42. If there is at least a location data of the remote module, step 421 is executed, the location of the remote module is then displayed on the instant communication module, and else step 43 is executed.

For example, a user can use an instant communication module comprising a memory, a processor and a WIFI transmission module, to execute the mentioned above steps. The instant communication program is stored in the memory and executed by the processor. While executing the instant communication program, the processor will drive the WIFI transmission module to connect an instant communication server which is maintained by the instant communication program provider. After connecting with the server, the user can enter ID and password to log on the server. If the logon successes, the user can exchange data with the friend who has registered in the server, and particularly can exchange message in real time if the friend also logs on the server.

In step 43, a position request is sent out to the remote module to ask the location data of the remote module. The contact can determine whether to respond the position request or not in step 44. If the contact wants to respond, step 45 is executed, else step 441 is executed and a message for failed positioning is displayed on the instant communication module.

In step 45, the contact enters a responding comment for control the remote module to send remote location data to the instant communication module, and the remote location data is then displayed on the map data by the instant communication module in step 46, so that the user can know the geographical location data of the remote module.

Preferably, the instant communication module can further comprise a network map searching engine for searching and downloading a plurality of network map from internet to display the remote location data.

Using the above mentioned steps, the present invention of the method for positing a contact can provide a location data of a remote module on the electronic map and the network map, therefore, it can provide assistance for the users of the instant communication module to know the geographical location data of the contact.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A instant communication module capable of positioning a contact comprising:
a signal transmitting and receiving unit for transmitting and receiving at least one signal;
a navigation unit for providing a location data, and having an electronic map database for storing a plurality of map data;
a storage unit for storing an instant communication program;
a processing unit for executing said instant communication program for exchanging a plurality of instant message and a position request with at least one remote module at an instant message platform by said signal transmitting and receiving unit, wherein said remote module sends a remote location data to said signal transmitting and receiving unit after receiving said position request, and said processing unit then positions and displays the location of said remote module on said map data based on the received remote location data; and
a display unit for displaying a visual operation interface of said instant communication program which can show said instant message and the location of said remote module.

2. The instant communication module capable of positioning a contact of claim 1, wherein said instant communication program is a Skype program, a MSN program or other telephone software program.

3. The instant communication module capable of positioning a contact of claim 1, wherein said instant message is a text message or a multimedia message.

4. The instant communication module capable of positioning a contact of claim 1, wherein said navigation unit comprises a global positioning system (GPS) module, a digital compass or a gyroscope.

5. The instant communication module capable of positioning a contact of claim 1, wherein said navigation unit can further comprise a network map searching unit for searching and downloading a plurality of network maps from a website.

6. The instant communication module capable of positioning a contact of claim 5, wherein said network map searching unit is a network map searching engine.

7. The instant communication module capable of positioning a contact of claim 1, wherein said visual operation interface comprises at least a dialog box and a map display box.

8. A method of positioning a contact, applied for an instant communication module, said method comprising the steps of:
executing an instant communication program in said instant communication module for exchanging a plurality of instant messages and a position request with at least one remote module;
searching whether there is a location data about said remote module or not, and displaying the location of said remote module if a location data about said remote module is searched, or sending a position request to said remote module if no location data about said remote module is searched;
determining by a user who operates said remote module whether to respond said position request or not, and sending a location data of said remote module to said instant communication module if said user accepts the position request; and
searching a map data corresponding to said location data of said remote module from an electronic map database and displaying said location data on said map data.

9. The method of claim 8, wherein said instant message is a text message or a multimedia message.

10. The method of claim 8, wherein said instant communication program is a Skype program, a MSN program or other telephone software program.

11. The method of claim 8, further comprising the steps of searching and downloading a plurality of network map from a website by an network map searching engine when said electronic map database can not search any information about said map data corresponding to said location data.

12. The method of claim 11, wherein said network map searching unit is a network map searching engine.
